(19) United States
(12) Patent Application Publication
(10) Pub. No.: US 2019/0304185 A1
(43) Pub. Date: Oct. 3, 2019

(54) METHOD AND APPARATUS FOR FILLING HOLE IN 3D MODEL

(71) Applicant: Electronics and Telecommunications Research Institute, Daejeon (KR)

(72) Inventors: Il Kyu PARK, Daejeon (KR); Kap Kee KIM, Daejeon (KR); Chang Joon PARK, Daejeon (KR); Jin Sung CHOI, Daejeon (KR)

(73) Assignee: Electronics and Telecommunications Research Institute, Daejeon (KR)

(21) Appl. No.: 16/374,602

(22) Filed: Apr. 3, 2019

(30) Foreign Application Priority Data
Apr. 3, 2018 (KR) 10-2018-0038861

(51) Int. Cl. G06T 17/20

(52) U.S. Cl. CPC G06T 17/205

(57) ABSTRACT

Disclosed is 3D information processing method and apparatus. The method of processing three-dimensional (3D) information for an object according to an embodiment of the present invention includes converting mesh model-based 3D information into 3D information of a half-edge structure; dividing a shell region of the object on the basis of connection information of half-edges included in the 3D information of the half-edge structure; determining at least one hole region of the object using the 3D information of the half-edge structure; determining at least one hole group obtained by grouping the at least one hole region of the object; and applying face information to the at least one hole group.

### CROSS REFERENCE TO RELATED APPLICATION

The present application claims priority to Korean Patent Application No. 10-2018-0038861, filed Apr. 3, 2018, the entire contents of which is incorporated herein for all purposes by this reference.

### BACKGROUND OF THE INVENTION

### Field of the Invention

The present disclosure generally relates to a technology for processing three-dimensional information for an object and, more particularly, to a method and an apparatus for processing information of a hole formed in an object.

### Description of the Related Art

Due to developments of information and communication technology, three-dimensional (3D) model information of an object is generated, or three-dimensional model information is utilized variously.

In particular, the 3D model information is input to a 3D printer device, so that various objects are restored or created. Generally, mesh model-based 3D information is used as data input to the 3D printer device.

Since the mesh model-based 3D information is generated based on information on the outer surface of the object, the object can be restored or generated based on the outer surface. However, the mesh model-based 3D information does not have enough information to restore or generate the internal shape of the object. In particular, when the 3D mesh model is provided with a hole, or when a specific face of the 3D mesh model is inverted in the opposite direction, it is constrained to express the object using the mesh model-based 3D information.

In this way, when the mesh model-based 3D information having limited information is used as input information of a 3D printer device, there are problems that an error may occur in performing 3D printing or other types of results may be output.

### SUMMARY OF THE INVENTION

It is an object of the present invention to provide a method and an apparatus capable of accurately detecting information of a hole included in mesh model-based 3D information.

It is another object of the present invention to provide a method and an apparatus capable of grouping at least one hole included in mesh model-based 3D information to be processed with the same face.

It will be appreciated that the technical objects to be achieved by the present disclosure are not limited to the above-mentioned technical objects, and other technical objects which are not mentioned are to be clearly understood from the following description to those skilled in the art.

In order to achieve the above objects, a method of processing three-dimensional (3D) information for an object according to an embodiment of the present disclosure includes converting mesh model-based 3D information into 3D information of a half-edge structure; dividing a shell region of the object on the basis of connection information of half-edges included in the 3D information of the half-edge structure; determining at least one hole region of the object using the 3D information of the half-edge structure; determining at least one hole group obtained by grouping the at least one hole region of the object; and applying face information to the at least one hole group.

An apparatus for processing 3D information for an object according to an embodiment of the present disclosure includes a half-edge conversion unit converting mesh model-based 3D information into 3D information of a half-edge structure; a shell region division unit dividing a shell region of the object on the basis of connection information of half-edges included in the 3D information of the half-edge structure; and a hole group processing unit determining at least one hole region of the object using the 3D information of the half-edge structure, determining at least one hole group obtained by grouping the at least one hole region of the object, and applying face information to the at least one hole group.

The features briefly summarized above for this disclosure are only exemplary aspects of the detailed description of the disclosure which follow, and are not intended to limit the scope of the disclosure.

According to the present disclosure, there is provided three-dimensional information processing method and apparatus capable of accurately detecting hole information included in mesh model-based 3D information, thereby eliminating an error that may be caused by a hole region without an input of a user.

Also, according to the present disclosure, three-dimensional information processing method and apparatus capable of grouping at least one hole region included in mesh model-based 3D information to be processed with same face can be provided.

Also, according to the present disclosure, three-dimensional information processing method and apparatus capable of preventing separation of at least one hole region included in mesh model-based 3D information can be provided.

The effects obtainable from the present disclosure are not limited to the effects mentioned above, and other effects not mentioned can be clearly understood by those skilled in the art from the description below.

### BRIEF DESCRIPTION OF THE DRAWINGS

The above and other objects, features and other advantages of the present invention will be more clearly understood from the following detailed description when taken in conjunction with the accompanying drawings, in which: FIG. 1 is a block diagram showing a configuration of a 3D information processing apparatus according to an embodiment of the present disclosure;

FIG. 2 is a diagram illustrating a relationship between an object and a shell region used in a 3D information processing apparatus according to an embodiment of the present disclosure;

FIG. 3A is a diagram illustrating a diameter of a hole region determined in a 3D information processing apparatus according to an embodiment of the present disclosure;

FIG. 3B is a diagram illustrating a center point of a hole region determined in a 3D information processing apparatus according to an embodiment of the present disclosure;

FIG. 4 is a flowchart showing a procedure of a three-dimensional information processing method according to an embodiment of the present disclosure; and

FIG. 5 is a block diagram illustrating a computing system for implementing 3D information processing apparatus and method according to an embodiment of the present disclosure.

### DETAILED DESCRIPTION OF THE INVENTION

Hereinbelow, exemplary embodiments of the present disclosure will be described in detail with reference to the accompanying drawings such that the present disclosure can be easily embodied by one of ordinary skill in the art to which this invention belongs. However, the present disclosure may be variously embodied, without being limited to the exemplary embodiments.

In the description of the present disclosure, the detailed descriptions of known constitutions or functions thereof may be omitted if they make the gist of the present disclosure unclear. Also, portions that are not related to the present disclosure are omitted in the drawings, and like reference numerals designate like elements.

In the present disclosure, when an element is referred to as being “coupled to”, “combined with”, or “connected to” another element, it may be connected directly to, combined directly with, or coupled directly to another element or be connected to, combined directly with, or coupled to another element, having the other element intervening therebetween. Also, it should be understood that when a component “includes” or “has” an element, unless there is another opposite description thereto, the component does not exclude another element but may further include the other element.

In the present disclosure, the terms “first”, “second”, etc. are only used to distinguish one element, from another element. Unless specifically stated otherwise, the terms “first”, “second”, etc. do not denote an order or importance. Therefore, a first element of an embodiment could be termed a second element of another embodiment without departing from the scope of the present disclosure. Similarly, a second element of an embodiment could also be termed a first element of another embodiment.

In the present disclosure, components that are distinguished from each other to clearly describe each feature do not necessarily denote that the components are separated. That is, a plurality of components may be integrated into one hardware or software unit, or one component may be distributed into a plurality of hardware or software units. Accordingly, even if not mentioned, the integrated or distributed embodiments are included in the scope of the present disclosure.

In the present disclosure, components described in various embodiments do not denote essential components, and some of the components may be optional. Accordingly, an embodiment that includes a subset of components described in another embodiment is included in the scope of the present disclosure. Also, an embodiment that includes the components described in the various embodiments and additional other components are included in the scope of the present disclosure.

Hereinafter, embodiments of the present disclosure will be described with reference to the accompanying drawings.

FIG. 1 is a block diagram showing a configuration of a 3D information processing apparatus according to an embodiment of the present disclosure.

A 3D information processing apparatus 10 according to an embodiment of the present disclosure may include a half-edge conversion unit 11, a shell region division unit 12, and a hole group processing unit 13.

The mesh model-based 3D information may include vertex information indicating vertices of the 3D mesh model and face information indicating faces formed by the vertex information. The vertex information may include an identifier (e. g., a vertex identification number) for each vertex and a coordinate value (x, y, z) indicating a three-dimensional position of the vertex. The face information may include a list of vertex identification numbers that makes up each face. For example, in the case of a triangular mesh model, each face may include identification numbers of three vertices, and in the case of a polygon mesh model, three or more vertex identification numbers may be included.

The half-edge conversion unit 11 may convert the mesh model-based 3D information as described above into three-dimensional information of a half-edge structure. For example, the half-edge conversion unit 11 may generate half-edge information indicating connectivity expressed using the vertex information and the face information an edge-based structure. The method of converting the mesh model-based 3D information (i.e., vertex information and face information) into 3D information of a half-edge structure (i.e., half-edge information) may be implemented by various methods used in the technical field of the present disclosure.

Furthermore, when converting the mesh model-based 3D information (i.e., vertex information and face information) into the 3D information of a half-edge structure (i.e., half-edge information), vertex information may be present in which the connectivity by the vertex information and the face information may not be converted into the information of the edge-based structure. In this case, the half-edge conversion unit 11 may define the overlapping of the vertex information of the corresponding portion and convert the same into half-edge information.

The shell region division unit 12 may divide a shell region of an object using the half-edge information. Specifically, it may be defined that there is connectivity when a plurality of half-edges is in a pair relation or any half-edge is in a neighboring relation with another half-edge. On the basis of this, the shell region division unit 12 may determine the half-edges having the connectivity as one half-edge group, and an entity consisting of the same half-edge groups may be determined as the shell region. Further, in determining the half-edge group, the shell region division unit 12 classifies the half-edges having connectivity into a half-edge group, and sets the half-edges included in different half-edge groups not to have connectivity with each other.

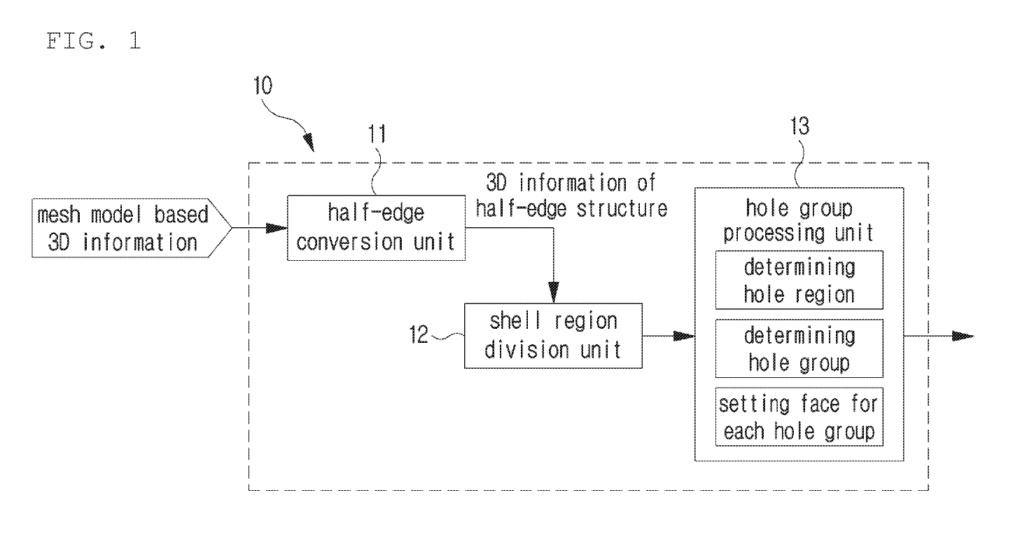

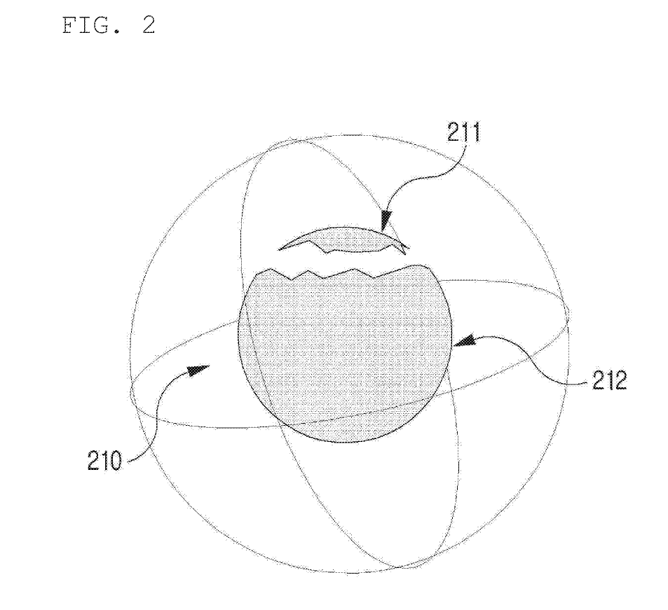

For example, referring to FIG. 2, an object 210 may include a first sub-object 211 and a second sub-object 212, and the first sub-object 211 and the second sub-object 212 may be provided in a state in which they are not connected to each other and are spaced apart by a predetermined distance. When the shell region is divided through the half-edge conversion unit 11 and the shell region division unit 12 using the mesh model-based 3D information for the object 210 of this type, it is possible to determine a region corresponding to the first sub-object 211 as the first shell region and a region corresponding to the second sub-object 212 as the second shell region.

Meanwhile, the hole group processing unit 13 may determine a hole region of the object using the half-edge information.

Specifically, the hole group processing unit 13 may check whether or not there is a face corresponding to each half-edge through the half-edge information. When there is no face corresponding to the half-edge, the hole group processing unit 13 may determine the corresponding half-edge as a hole half-edge.

The hole half-edges may be generated continuously to be adjacent. In consideration of this, when any half-edge (e.g., the first half-edge) is determined as a hole half-edge, the hole group processing unit 13 may determine whether or not there is a face corresponding to a half-edge (second half-edge) adjacent to the first half-edge, thereby determining whether or not the half-edge is the hole half-edge. The hole group processing unit 13 may repeatedly perform the above-mentioned operation, i. e., the operation of checking whether or not the half-edge is the hole half-edge. In this case, when the half-edge is continuously determined as the hole half-edge, the hole group processing unit 13 may repeatedly perform the operation of checking whether or not the half-edge is the hole half-edge, by the first half-edge described above.

Furthermore, the hole group processing unit 13 may list and store the half-edges determined as the hole half-edges. In addition, when the half-edges determined as the hole half-edges exist continuously, the hole group processing unit 13 may use the information stored in the list, thereby determining the corresponding half-edges as a hole region.

The hole group processing unit 13 may determine the hole group obtained by grouping the hole regions in consideration of a relationship between the shell region and the hole region. In this case, the hole group processing unit 13 may determine the hole group by further considering geometrical information of the hole region, a relationship between adjacent hole regions, and the like.

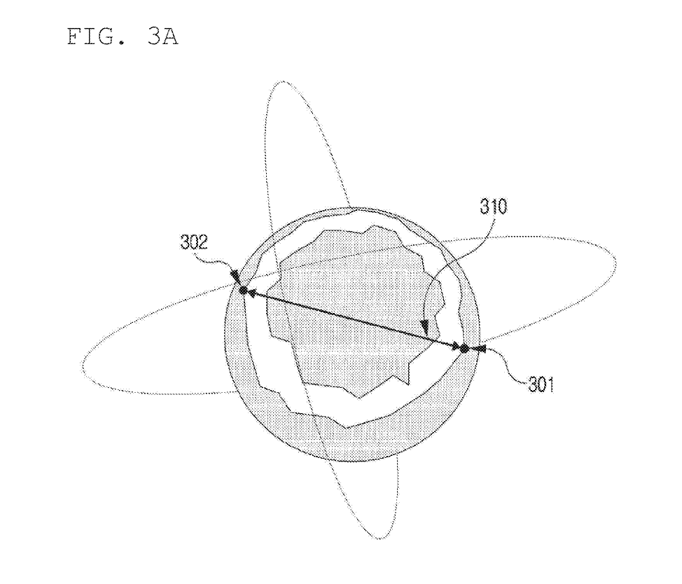

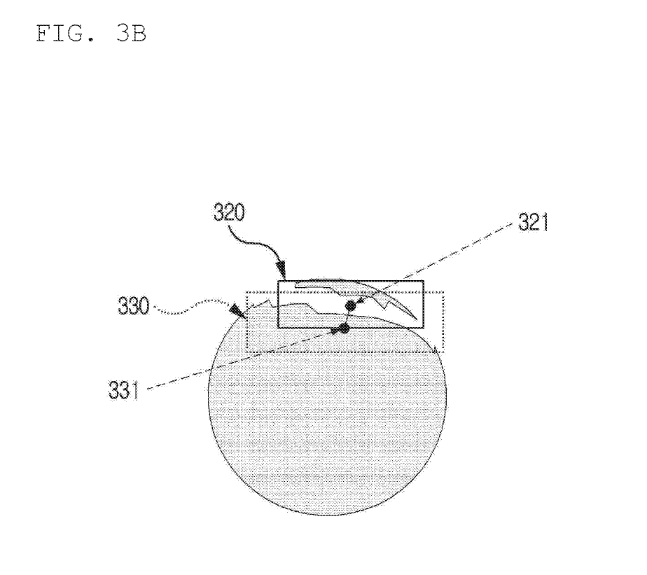

Specifically, when the hole regions are provided in the same shell region, the hole group processing unit 13 may determine that the hole regions are different from each other. When a plurality of hole regions are provided in different shell regions, the hole group processing unit 13 may determine the hole groups in consideration of distance information between the plurality of hole regions and diameter information of the hole region. For example, the hole group processing unit 13 may check diameter information of a plurality of hole regions, in which the diameter of the hole region 310 (see FIG. 3A) is used to determine vertices included in the hole region, and the distance between the vertices 301 and 302 located at the farthest distance relative to each other among the checked vertices may be determined as the diameter information of the hole region. In addition, the hole group processing unit 13 may determine the distance between the center points 321 and 331 included in the plurality of hole regions 320 and 330 (see FIG. 3B) as the distance information.

Further, the hole group processing unit 13 may compare the value obtained by doubling the diameter information of the hole region and the distance information between the different hole regions, and when the value obtained by doubling the diameter information of the hole region is relatively larger than the distance between the plurality of hole regions, the plurality of hole regions may be determined as the hole group.

The hole group processing unit 13 may apply a single face to the hole group.

Further, the hole group processing unit 13 may provide an input interface for selecting whether to generate a face for each hole group or to generate a face for each hole region, and it is possible to create a face for each hole group or a face for each hole region, on the basis of information input through the input interface.

In this way, since a single face is applied for each hole group, the hole region may be actively set without a user's input for setting the hole region and the problem of mesh's being separated may be solved.

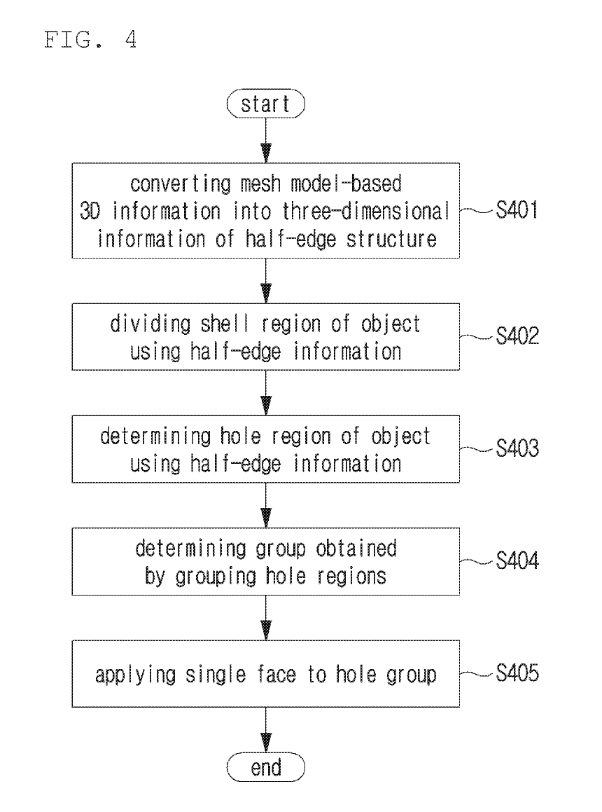

FIG. 4 is a flowchart showing a procedure of a three-dimensional information processing method according to an embodiment of the present disclosure.

A 3D information processing method according to an embodiment of the present disclosure may be performed by a 3D information processing apparatus according to an embodiment of the present disclosure described above.

First, in step S401, the 3D information processing apparatus receives mesh model-based 3D information and converts the same into three-dimensional information of a half-edge structure.

Specifically, the mesh model-based 3D information may include vertex information indicating vertices of the 3D mesh model and face information indicating a face formed by the vertex information. The vertex information may include an identifier (e.g., a vertex identification number) for each vertex and a coordinate value (x, y, z) indicating a three-dimensional position of the vertex. The face information may include a list of vertex identification numbers that make up each face. For example, in the case of a triangular mesh model, each face may include three vertices identification numbers, and in the case of a polygon mesh model, three or more vertex identification numbers may be included.

The converted half-edge information may include information indicating connectivity expressed using the vertex information and the face information as an edge-based structure. The method of converting the mesh model-based 3D information (i.e., vertex information and face information) into 3D information of a half-edge structure (i.e., half-edge information) may be implemented by various methods used in the technical field of the present disclosure.

Furthermore, when converting the mesh model-based 3D information (i.e., vertex information and face information) into the 3D information of a half-edge structure (i.e., half-edge information), vertex information may be present in which the connectivity by the vertex information and the face information may not be converted into the information of the edge-based structure. In this case, the 3D information processing apparatus may define the overlapping of the vertex information of the corresponding portion and convert the same into half-edge information.

In step S402, the 3D information processing apparatus may divide the shell region of the object using half-edge information.

Specifically, it may be defined that there is connectivity when a plurality of half-edges is in a pair relation or any half-edge is in a neighboring relation with another half-edge. On the basis of this, the 3D information processing apparatus may determine the half-edges having the connectivity as one half-edge group, and an entity consisting of the same half-edge groups may be determined as the shell region. Further, in determining the half-edge group, the 3D information processing apparatus classifies the half-edges having connectivity into a half-edge group, and sets the half-edges included in different half-edge groups not to have connectivity with each other.

For example, referring to FIG. 2, an object 210 may include a first sub-object 211 and a second sub-object 212, and the first sub-object 211 and the second sub-object 212 may be provided in a state in which they are not connected to each other and are spaced apart by a predetermined distance. When the shell region is divided using the mesh model-based 3D information for the object 210 of this type, it is possible to determine a region corresponding to the first sub-object 211 as the first shell region and a region corresponding to the second sub-object 212 as the second shell region.

In step S403, the 3D information processing apparatus may determine a hole region of the object using the half-edge information. Specifically, the 3D information processing apparatus may check whether or not there is a face corresponding to each half-edge through the half-edge information. When there is no face corresponding to the half-edge, the 3D information processing apparatus may determine the corresponding half-edge as a hole half-edge.

The hole half-edges may be generated continuously to be adjacent. In consideration of this, when any half-edge (e.g., the first half-edge) is determined as a hole half-edge, the 3D information processing apparatus may determine whether or not there is a face corresponding to a half-edge (second half-edge) adjacent to the first half-edge, thereby determining whether or not the half-edge is the hole half-edge. The 3D information processing apparatus may repeatedly perform the above-mentioned operation, i. e., the operation of checking whether or not the half-edge is the hole half-edge. In this case, when the half-edge is continuously determined as the hole half-edge, the hole group processing unit 13 may repeatedly perform the operation of checking whether the half-edge is the hole half-edge, by the first half-edge described above.

Furthermore, the 3D information processing apparatus may list and store the half-edges determined as the hole half-edges. In addition, when the half-edges determined as the hole half-edges exist continuously, the 3D information processing apparatus may use the information stored in the list to determine the corresponding half-edges as a hole region.

In step S404, the 3D information processing apparatus may determine the hole group obtained by grouping the hole regions in consideration of a relationship between the shell region and the hole region. In this case, the 3D information processing apparatus may determine the hole group by further considering geometrical information of the hole region, a relationship between adjacent hole regions, and the like.

Specifically, when the hole regions are provided in the same shell region, the 3D information processing apparatus may determine that the hole regions are different from each other. When a plurality of hole regions is provided in different shell regions, the 3D information processing apparatus may determine the hole groups in consideration of distance information between the plurality of hole regions and diameter information of the hole region. For example, the 3D information processing apparatus may check diameter information of a plurality of hole regions, in which the diameter of the hole region 310 (see FIG. 3A) is used to determine vertices included in the hole region, and the distance between the vertices 301 and 302 located at the farthest distance relative to each other among the checked vertices may be determined as the diameter information of the hole region. In addition, the 3D information processing apparatus may determine the distance between the center points 321 and 331 included in the plurality of hole regions 320 and 330 (see FIG. 3B) as the distance information.

Further, the 3D information processing apparatus may compare the value obtained by doubling the diameter information of the hole region and the distance information between the different hole regions, and when the value obtained by doubling the diameter information of the hole region is relatively larger than the distance between the plurality of hole regions, the plurality of hole regions may be determined as the hole group.

Meanwhile, in step S405, the 3D information processing apparatus may apply a single face to the hole group.

Further, the 3D information processing apparatus may provide an input interface for selecting whether to generate a face for each hole group or to generate a face for each hole region, and it is possible to create a face for each hole group or a face for each hole region, on the basis of information input through the input interface.

In this way, since a single face is applied for each hole group, the hole region may be actively set without a user's input for setting the hole region and the problem of mesh's being separated may be solved.

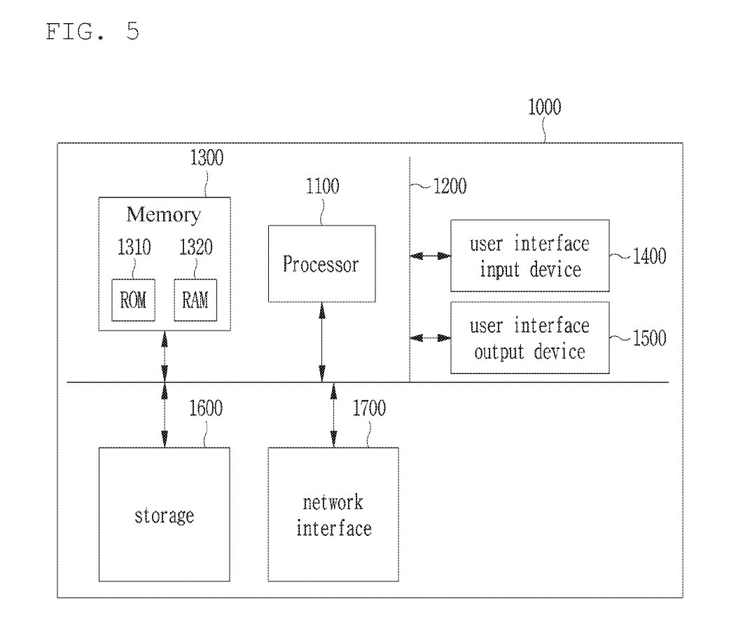

FIG. 5 is a block diagram illustrating a computing system for implementing 3D information processing apparatus and method according to an embodiment of the present disclosure.

Referring to FIG. 5, a computing system 100 may include at least one processor 1100 connected through a bus 1200, a memory 1300, a user interface input device 1400, a user interface output device 1500, a storage 1600, and a network interface 1700.

The processor 1100 may be a central processing unit or a semiconductor device that processes commands stored in the memory 1300 and/or the storage 1600. The memory 1300 and the storage 1600 may include various volatile or nonvolatile storing media. For example, the memory 1300 may include a ROM (Read Only Memory) and a RAM (Random Access Memory).

Accordingly, the steps of the method or algorithm described in relation to the embodiments of the present disclosure may be directly implemented by a hardware module and a software module, which are operated by the processor 1100, or a combination of the modules. The software module may reside in a storing medium (that is, the memory 1300 and/or the storage 1600) such as a RAM memory, a flash memory, a ROM memory, an EPROM memory, an EEPROM memory, a register, a hard disk, a detachable disk, and a CD-ROM. The exemplary storing media are coupled to the processor 1100 and the processor 1100 can read out information from the storing media and write information on the storing media. Alternatively, the storing media may be integrated with the processor 1100. The processor and storing media may reside in an application specific integrated circuit (ASIC). The ASIC may reside in a user terminal. Alternatively, the processor and storing media may reside as individual components in a user terminal.

The exemplary methods described herein were expressed by a series of operations for clear description, but it does not limit the order of performing the steps, and if necessary, the steps may be performed simultaneously or in different orders. In order to achieve the method of the present disclosure, other steps may be added to the exemplary steps, or the other steps except for some steps may be included, or additional other steps except for some steps may be included.

Various embodiments described herein are provided to not arrange all available combinations, but explain a representative aspect of the present disclosure and the configurations about the embodiments may be applied individually or in combinations of at least two of them.

Further, various embodiments of the present disclosure may be implemented by hardware, firmware, software, or combinations thereof. When hardware is used, the hardware may be implemented by at least one of ASICs (Application Specific Integrated Circuits), DSPs (Digital Signal Processors), DSPDs (Digital Signal Processing Devices), PLDs (Programmable Logic Devices), FPGAs (Field Programmable Gate Arrays), a general processor, a controller, a micro controller, and a micro-processor.

The scope of the present disclosure includes software and device-executable commands (for example, an operating system, applications, firmware, programs) that make the method of the various embodiments of the present disclosure executable on a machine or a computer, and non-transitory computer-readable media that keeps the software or commands and can be executed on a device or a computer.

1. A method of processing three-dimensional (3D) information for an object, the method comprising:
converting mesh model-based 3D information into 3D information of a half-edge structure;
dividing a shell region of the object on the basis of connection information of half-edges included in the 3D information of the half-edge structure;
determining at least one hole region of the object using the 3D information of the half-edge structure;
determining at least one hole group obtained by grouping the at least one hole region of the object; and
applying face information to the at least one hole group.

2. The method of claim 1, wherein the mesh model-based 3D information includes vertex information indicating vertices of the 3D mesh model and face information indicating faces formed by the vertex information.

3. The method of claim 1, wherein the dividing of the shell region of the object includes:
determining whether the half-edges are connected or not from the connection information of the half-edges; and
grouping the connected half-edges to be determined as the shell region of the object.

4. The method of claim 1, wherein the determining of the hole regions of the object includes:
determining whether or not there is a face to which the half-edge belong for the half-edge; and
when there is no face to which the half-edge belong, determining a region corresponding to the half-edge as the hole region.

5. The method of claim 1, wherein the determining of the at least one hole group includes:
determining whether at least one hole region is included in the same shell region; and
determining the at least one hole region as hole groups different from each other or determining the at least one hole region as the same hole group, on the basis of whether the at least one hole region is included in the same shell region.

6. The method of claim 5, wherein the determining of the at least one hole group includes:
determining the at least one hole region as the hole groups different from each other, when the at least one hole region is included in the same shell region.

7. The method of claim 5, wherein the determining of the at least one hole group includes:
determining diameter information of the at least one hole region and a distance between the at least one hole region, when the at least one hole region is included in the shell regions different from each other; and
determining the at least one hole region as the hole group in consideration of the diameter information of the at least one hole region and the distance between the at least one hole region.

8. The method of claim 7, wherein the determining of the at least one hole region as the hole group includes:
comparing a value obtained by doubling the diameter information of the at least one hole region with the distance between the at least one hole region; and
determining the at least one hole region as the hole group, when the value obtained by doubling the diameter information of the at least one hole region is relatively greater than the distance between the at least one hole region.

9. The method of claim 7, wherein the determining of the diameter information of the at least one hole region includes:
determining vertices corresponding to the hole region; and
determining a distance between the vertices located at the farthest distance relatively among the vertices corresponding to the hole region as the diameter information of the hole region.

10. An apparatus for processing 3D information for an object, the apparatus comprising:
a half-edge conversion unit converting mesh model-based 3D information into 3D information of a half-edge structure;
a shell region division unit dividing a shell region of the object on the basis of connection information of half-edges included in the 3D information of the half-edge structure; and
a hole group processing unit determining at least one hole region of the object using the 3D information of the half-edge structure, determining at least one hole group obtained by grouping the at least one hole region of the object, and applying face information to the at least one hole group.

11. The apparatus of claim 10, wherein the shell region division unit
determines whether the half-edges are connected or not from the connection information of the half-edges; and
groups the connected half-edges to be determined as the shell region of the object.

12. The apparatus of claim 10, wherein the hole group processing unit
determines whether or not there is a face to which the half-edge belongs for the half-edge; and
when there is no face to which the half-edge belongs, determines a region corresponding to the half-edge as the hole region.

13. The apparatus of claim 10, wherein the hole group processing unit,
determines whether at least one hole region of the hole regions is included in the same shell region; and
determines the at least one hole region as hole groups different from each other or determining the at least one hole region as the same hole group, on the basis of whether the at least one hole region is included in the same shell region.

14. The apparatus of claim 13, wherein when the at least one hole region is included in the same shell region, the hole group processing unit determines the at least one hole region as the hole groups different from each other.

15. The apparatus of claim 13, wherein the hole group processing unit,
when the at least one hole region is included in the shell regions different from each other, determines diameter information of the at least one hole region and a distance between the at least one hole region; and
determines the at least one hole region as the hole group in consideration of the diameter information of the at least one hole region and the distance between the at least one hole region.

16. The apparatus of claim 15, wherein the hole group processing unit
compares a value obtained by doubling the diameter information of the at least one hole region with the distance between the at least one hole region; and
when the value obtained by doubling the diameter information of the at least one hole region is relatively greater than the distance between the at least one hole region, determines the at least one hole region as the hole group.

17. The apparatus of claim 15, wherein the hole group processing unit
determines vertices corresponding to the hole region; and
determines a distance between the vertices located at the farthest distance relatively among the vertices corresponding to the hole region as the diameter information of the hole region.
